(19) United States
(12) Patent Application Publication
(10) Pub. No.: US 2015/0323733 A1
(43) Pub. Date: Nov. 12, 2015

(54) LUMINESCENT DEVICE

(71) Applicant: NEC Corporation, Tokyo (JP)

(72) Inventor: Naofumi SUZUKI, Tokyo (JP)

(21) Appl. No.: 14/424,273

(22) PCT Filed: Sep. 3, 2013
(86) PCT No.: PCT/JP2013/005197

§ 371 Date: Feb. 26, 2015

(30) Foreign Application Priority Data
Sep. 4, 2012 (JP) 2012-194034

(51) Int. Cl. F21V 8/00; F21V 13/04

(52) U.S. Cl. CPC G02B 6/0096; F21V 13/04; F21Y 2101/02

(57) ABSTRACT

[Problem]

To collect emitted light while sufficiently improving light extraction efficiency of a light emitting element, and to make it easy for the emitted light to enter the optical system of a latter stage.

[Solution]

A light emitting element and a taper rod having the area of its emission plane larger than that of its incidence plane are provided, and a transparent resin is filled between the light emitting element and the taper rod. At least part of the taper rod has a refractive index higher than that of the transparent resin.

### TECHNICAL FIELD

The present invention relates to a luminescent device used for a light source of an image apparatus mainly.

### BACKGROUND ART

In recent years, a projector using an LED (Light Emitting Diode: light emitting diode) is paid attention as a light source. In such projector, it is often the case that it has a plurality of light sources which emit red, green and blue light, respectively, to display a color picture. In order to make a projector be of higher intensity and lower power consumption, increase in efficiency of LEDs which are its light sources is important. For improvement of efficiency of an LED, it is necessary to improve the internal quantum efficiency and the light extraction efficiency. Between the both, as a means to improve light extraction efficiency, a fine concavo-convex structure called a textured structure or a photonic crystal is formed in a surface of recent devices. For example, there is description about such structure in non-patent literature 1. However, even for a device using this method, it cannot be said that the light extraction efficiency is high sufficiently.

On the other hand, in an application such as lighting, there is used a method to stick a hemispherical lens on an LED via a resin as is the case with non-patent literature 2. In this structure, a resin is applied on an LED having the above-mentioned textured structure or the like, and a hemispherical lens is arranged on it. A resin and a hemispherical lens of almost equal refractive indexes are chosen in order to reduce reflection at their surface boundary. When the area of the bottom face of a hemispherical lens is larger sufficiently than the luminous area of an LED, most of light taken out into the resin can be taken out into the air. Accordingly, light extraction efficiency of an LED is improved.

### CITATION LIST

### Non Patent Literature

[NPL 1] R. Windisch et. al., “Impact of texture-enhanced transmission on high-efficiency surface-textured light-emitting diodes”, APL vol. 79, no. 15, pp. 2315-7 (2001)
[NPL 2] Sugimoto et. al., “High power white LED light-source for lighting”, Matsushita Electric Works technical report, Vol. 53, No. 1, pp. 4-9 (2007)

### Patent Literature

[PTL 1] Published Japanese translation of PCT application No. 2009-530671

### SUMMARY OF INVENTION

### Technical Problem

Because, in the structure using a hemispherical lens mentioned above, it is difficult to collect light that has been taken out, and thus, while it suits an application of such as lighting in which it is desired to irradiate a wide range, it does not suit an application such as a projector in which light from a light source is needed to be gathered into an optical component of a relatively small area such as a light valve. If a light source having such structure is applied to a projector, although light extraction efficiency from an LED to the air is improved compared with the case of a simple LED, light utilization efficiency in the optical system of its latter stage becomes substantially low, resulting in decline of efficiency as a whole projector.

The present invention has been made in view of such problem, and its object is to provide a luminescent device that can easily collect emitted light and make it enter the latter-stage optical system, while improving the light extraction efficiency of an LED sufficiently.

### Solution to Problem

A luminescent device of the present invention includes a light emitting element and a taper rod having the area of its emission plane larger than that of its incidence plane, in which a transparent resin is filled between the light emitting element and the taper rod, and at least part of the taper rod has a refractive index higher than that of the transparent resin. Here, that part of a taper rod has a refractive index higher than that of a transparent resin includes, in addition to a case where the body of the taper rod is formed by a material such as glass having a refractive index higher than that of the resin between a light emitting element and the taper rod, a case where, although the refractive index of the taper rod body is equal to or lower than that of the transparent resin, the taper rod has a multilayer film including a material of a refractive index higher than that of the transparent resin in its side faces.

### Advantageous Effects of Invention

According to a structure of the present invention, it is possible to improve efficiency of light extraction from an LED and to collect emitted light easily.

### BRIEF DESCRIPTION OF DRAWINGS

FIG. 1 is a sectional view showing a structure of a luminescent device in a first exemplary embodiment of the present invention.

FIG. 2 is a diagram showing measured values of light output characteristics of a first example of the present invention.

FIG. 3 is a sectional view showing a structure of a luminescent device in a second exemplary embodiment of the present invention.

FIG. 4 is a sectional view showing a structure of a luminescent device in a third exemplary embodiment of the present invention.

FIG. 5 is a sectional view showing a structure of a luminescent device in a fifth exemplary embodiment of the present invention.

FIG. 6 is a sectional view showing a structure of a luminescent device in a sixth exemplary embodiment of the present invention.

FIG. 7 is a diagram for describing a definition of a desirable area ratio of a taper rod in a case where a plurality of taper rods are connected via a transparent resin in the present invention.

### DESCRIPTION OF EMBODIMENTS

### First Exemplary Embodiment

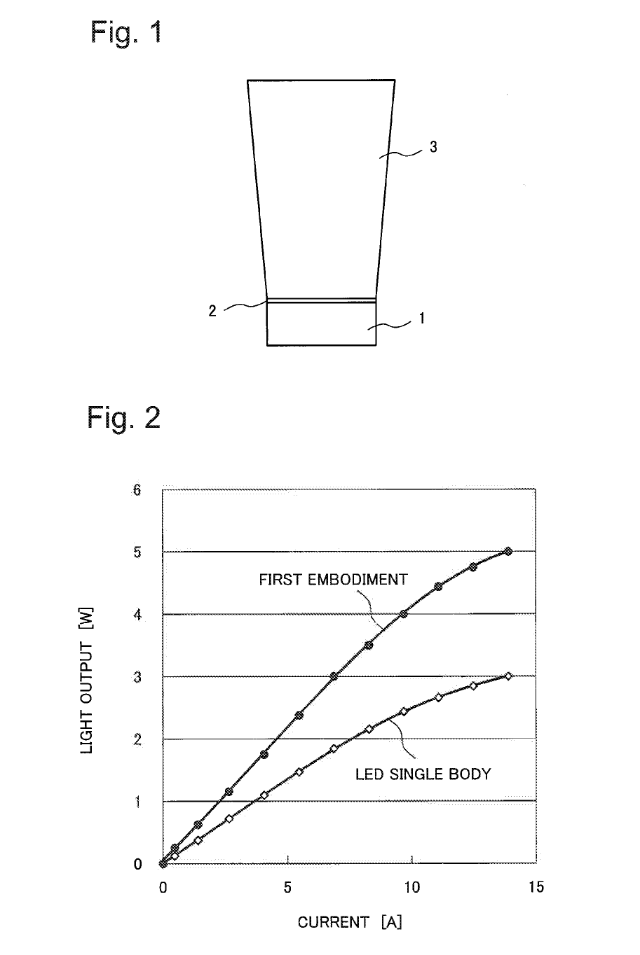

Referring to the drawings, the embodiments of the present invention will be described. FIG. 1 is a sectional view showing a structure of a luminescent device in the first exemplary embodiment of the present invention.

The luminescent device shown in FIG. 1 includes an LED 1, a transparent resin 2 and a taper rod 3. The LED 1 is an LED that emits red light taking AlGaInP as an active layer. A refractive index of the transparent resin 2 is 1.41, and a refractive index of the taper rod 3 is 2.15. The LED 1 has a light emitting surface of a size of 2×2.7 mm and an area of 5.4 mm². The incidence plane and the emission plane of the taper rod 3 are of 2×2.7 mm and 2.83×3.82 mm, respectively, and their areas are 5.4 mm² and 10.8 mm², and the length of the taper rod 3 is made to be 9.4 mm. Anti-reflection films aimed at the air and a transparent resin are formed onto the incidence plane and the emission plane of the taper rod 3, respectively. The thickness of the transparent resin 2 is about 10 μm.

FIG. 2 is a diagram showing measured values of light output characteristics of the first example of the present invention.

For comparison, measured values of light output characteristics of the LED single body is also indicated together in FIG. 2. In this exemplary embodiment, light output of about 1.65 times of the case of the LED single body has been obtained, and thus remarkable improvement of light extraction efficiency has been confirmed.

Next, operations of a luminescent device in this exemplary embodiment will be described. First, consideration about a structure in which just a resin is applied to an LED will be made. Because the ratio of the refractive indexes of an LED and a resin is smaller than that of the LED and the air, light extraction efficiency from the LED into the resin is higher than light extraction efficiency from the LED to the air. However, light extraction efficiency from the LED to the air in this structure will be a value made by multiplying the light extraction efficiency from the LED to the resin and the light extraction efficiency from the resin to the air, and that value does not differ from efficiency when light is extracted from the LED to the air directly. On the other hand, when the taper rod 3 is arranged on the transparent resin 2 as has been taken as an example in the above exemplary embodiment, light which is totally reflected by the emission plane decreases substantially because an angle transformation of light is conducted in the taper rod. For this reason, light extraction efficiency when light goes out to the air from a transparent resin through a taper rod is higher substantially than a case when it goes out to the air directly from the transparent resin. Accordingly, light extraction efficiency from the LED 1 to the air in this exemplary embodiment is higher than a case extracting light to the air directly from the LED. Meanwhile, in this structure, it is needed that light does not leak out to outside at the time of reflection at a side face of the taper rod 3. Therefore, it is desirable to make the refractive index of the taper rod 3 higher than the refractive index of the transparent resin 2 enough. By this, light of all inclined angles having entered into the taper rod 3 from the transparent resin 2 is totally reflected when it reaches a side face, and light leak from the side face will not occur. Specifically, given that the refractive index of a transparent resin is n1, the refractive index of a taper rod is n2, and the taper angle of the taper rod is θt, it is desirable to fill the following formula.

n2×cos {sin⁻¹(n1/n2)−θt}≧1 (1)

In this example, the taper angles in the side of the short sides of the rectangles of the incidence plane and the emission plane is 2.53 degrees, and the long side 3.41 degrees. On the other hand, the refractive index of the taper rod 3 is 2.15 and is sufficiently higher than the refractive index of the transparent resin 2 of 1.41, and thus the above formula (1) is satisfied sufficiently.

When such condition is not satisfied, light leaks from a side face of a taper rod. For example, in patent literature 1, there is disclosed a structure in which the refractive indexes of a taper rod and a transparent resin are made consistent with each other, that is, n2≅n1, is disclosed. However, in this structure, part of light which has entered the taper rod leaks from a side face and will not reach the emission plane. For this reason, utilization efficiency of light declines in image equipment such as a projector. Although light leak from a side face can be reduced by applying reflective coating on the whole surface of the side faces of a taper rod, this accompanies substantial cost increase. In contrast, when filling the above-mentioned Formula (1), light leak from a side face can be prevented without applying such coating.

Meanwhile, here, as a general condition, it is supposed that the surroundings of the side faces of a taper rod is the air, that is, the refractive index is 1. Also, as a taper rod, a taper rod having a fixed taper angle is considered. In this case, the above Formula (1) will be the necessary and sufficient condition not to allow light to leak out from a side face of a taper rod. In the case where a taper angle is not fixed, given that the biggest taper angle is made to be θt, Formula (1) will represent the necessary condition not to allow light to leak out from a side face. Also, in the case where a side face of a taper rod is covered by a transparent medium, that is, when the refractive index around the side face is larger than 1, Formula (1) will be the necessary condition not to allow light to leak out from the side face. However, when considering easiness of the optical confinement and simplicity of a structure, it is desirable that the surroundings of a side face of a taper rod be the air at least mostly.

Next, a desirable structure of a taper rod will be described from a point of improvement of efficiency of extracting light from an LED. Regarding whole light which has entered an incidence plane of a taper rod from a transparent resin in this structure, in order to prevent total reflection at an emission plane and to take it out to the air, it is needed for the emission area of the taper rod that the ratio of it to the incidence area is equal to or more than the refractive index of the resin raised to the second power according to the Etendue conservation law. When an emission/incidence area ratio is smaller than this, extraction efficiency declines because part of the light is totally reflected at the emission plane.

In the above exemplary embodiment, the emission/incidence area ratio of the taper rod 3 is 2 and is larger than 1.99 which is the square of the refractive index of the transparent resin 2, and thus the above condition is satisfied. For this reason, efficient light extraction is realized.

### Second Exemplary Embodiment

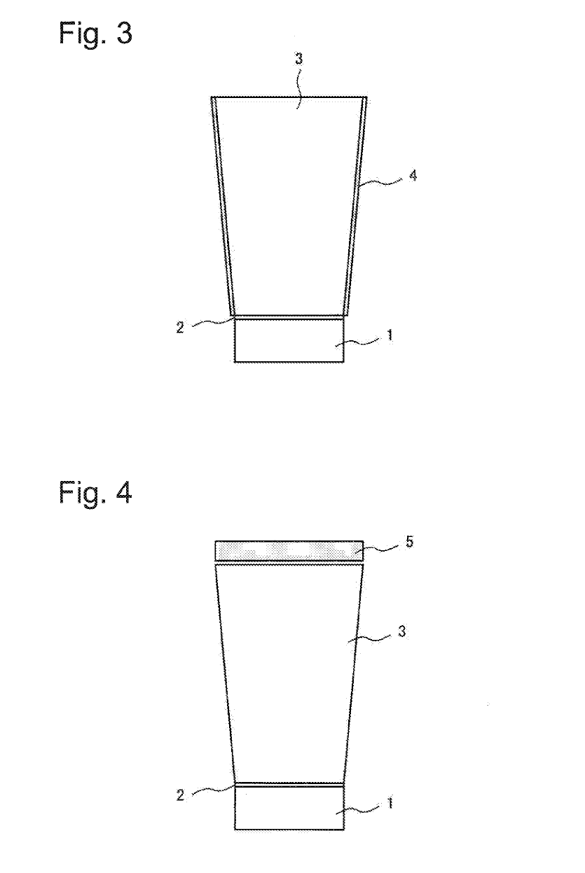

A luminescent device according to the second exemplary embodiment of the present invention will be described. FIG. 3 is a sectional view showing a structure of a luminescent device in the second exemplary embodiment of the present invention.

The second exemplary embodiment of the present invention includes an LED 1, a transparent resin 2 and a taper rod 3 just like the first exemplary embodiment. Although the LED 1 and the transparent resin 2 are the same as those of the first exemplary embodiment, the refractive index of the taper rod 3 is 1.52 and is smaller than that of the first exemplary embodiment. In this case, because a refractive index ratio between the transparent resin 2 and the taper rod 3 is small, part of light is not totally reflected at a side face of the taper rod. Therefore, light leaking from a side face of the taper rod to outside is prevented by forming a high reflection coating 4 made of dielectrics onto all side faces.

### Third Exemplary Embodiment

A luminescent device according to the third exemplary embodiment of the present invention will be described. FIG. 4 is a sectional view showing a structure of a luminescent device in the third exemplary embodiment of the present invention.

In addition to an LED 1, a transparent resin 2 and a taper rod 3 that are the same as those of the first exemplary embodiment, an angle filter 5 is arranged in the third exemplary embodiment of the present invention. The angle filter 5 has characteristics by which, although light within a given incident angle penetrates through it, light of an angle larger than that is reflected. Part of light which has entered the angle filter 5 with a large incident angle is reflected, and returns to the side of the LED 1 through the taper rod 3 and the transparent resin 2, and is reflected by the LED 1. Because a textured structure or a photonic crystal described before is formed in the surface of the LED 1, the angle of light is changed at the time of reflection by the LED 1. Although light reflected by the LED 1 goes to the angle filter 5 through the transparent resin 2 and the taper rod 3 again, the light which has entered the angle filter 5 again also includes light having a small incident angle because the angle of light is changed at the time of reflection by the LED 1 as stated first. Accordingly, part of the light penetrates through the angle filter 5. On the other hand, light of a large angle is reflected. By repeating this, only light within a given angle is taken out from a light source of the embodiment of FIG. 4. This angle filter 5 works even when it is arranged on the LED 1. However, in this exemplary embodiment, there are advantages compared with a case arranged directly on the LED 1. One advantage is that light extraction efficiency from the LED 1 is high as has been described up to now, and, in addition to that, there is an advantage that a re-utilization efficiency of light is high. As mentioned above, light with a large incident angle is reflected by the LED 1 after having reflected by the angle filter 5, and enters the angle filter 5 again. In other words, reflected light is reused. The reflected light is not used fully, and part of it becomes loss. Main loss is produced by the reflectivity of the LED 1 being not high sufficiently. Because much of light which has entered the LED 1 enters inside the LED 1, reflectivity of the LED 1 depends on efficiency of extraction of light from the LED 1 greatly, and the higher the light extraction efficiency is, the higher the reflectivity is, generally. In the structure of the present invention, because light extraction efficiency from the LED 1 can be made high, reflectivity of the LED 1 also becomes high. Accordingly, in the form of this example, re-utilization efficiency of light is high compared with a case when an angle filter is arranged just above the LED, and, as a result, efficiency to take out light within a given angle is high.

### Fourth Exemplary Embodiment

A luminescent device according to the fourth exemplary embodiment of the present invention will be described.

The fourth exemplary embodiment of the present invention includes an LED 1, a transparent resin 2 and a taper rod 3 just like the first embodiment. The LED 1 and the transparent resin 2 are the same as those of the first embodiment. However, the taper rod 3 is different. While the incidence plane of the taper rod 3 is of 5.4 mm², its emission plane is of 52 mm², and thus an area ratio between the incidence plane and the emission plane is about 9.6. The length of the taper rod is 50 mm, and its refractive index is 1.9. In the first example, while the square of the refractive index of the resin 2 is 1.99, the area ratio of the incidence and emission surfaces is 2, and thus both of them are almost equal. In this case, angular distribution of light emitted from the emission plane of the taper rod 3, that is, light intensity distribution is equal to the light intensity distribution of the LED 1 mostly. In a general LED, light intensity distribution follows Lambertian and is distributed over angles of 0-90 degrees, and, when this LED 1 is used for the first exemplary embodiment, the light intensity distribution from the taper rod 3 also follows Lambertian similarly, and is distributed over approximately 0-90 degrees. On the other hand, in this exemplary embodiment, the area ratio between the incidence and emission planes is 9.6, and is larger sufficiently compared with the square of the refractive index of the transparent resin 2. In this case, by angle transformation in the taper rod, light intensity distribution at the emission plane changes. In this case, most light is distributed in roughly 0-30 degrees. That is, the taper rod 3 in this exemplary embodiment has a function of light intensity distribution conversion of emitted light in addition to improvement of light extraction efficiency from the LED 1.

### Fifth Exemplary Embodiment

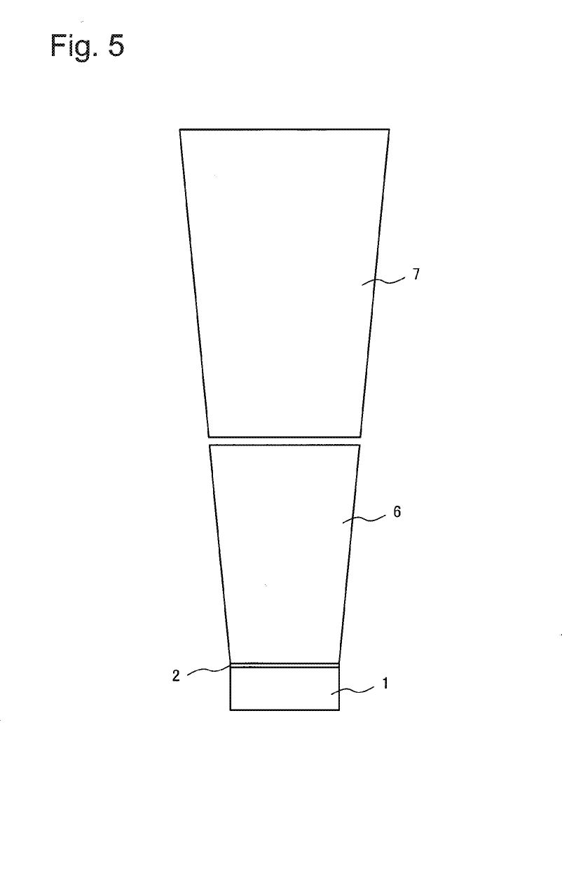

A luminescent device according to the fifth exemplary embodiment of the present invention will be described. FIG. 5 is a sectional view showing a structure of a luminescent device in the fifth exemplary embodiment of the present invention.

In the fifth exemplary embodiment of the present invention, there is connected a first taper rod 6 on an LED 1 via a transparent resin 2, and, further, a second taper rod 7 is arranged in the latter stage. The LED 1, the transparent resin 2 and the first taper rod 6 are the same as the first embodiment. The second taper rod 7 has the area of the incidence plane of 10.8 mm², and the area of the emission plane of 52 mm². That is, the areas of the emission plane of the first taper rod 6 and the incidence plane of the second taper rod 7 are the same. The length of the second taper rod 7 is 35 mm, and its refractive index is 1.52. The first taper rod 6 and the second taper rod 7 are arranged immediately close to each other, and the distance is 50 μm or less. Anti-Reflective Coating aimed at the air is formed into incidence and emission planes of the second taper rod 7. Also in this embodiment, light extraction efficiency is improved compared with an LED single body, and almost all light emitted from the second taper rod 7 is distributed within 0-30 degrees. That is, although the overall function of this embodiment is the same as that of the fourth exemplary embodiment, this embodiment includes the following advantages. While the first taper rod 6 is made of high refractive index glass of a refractive index of 2.15, the second taper rod 7 is made of glass of a refractive index of 1.52 that is a general refractive index. Although the first taper rod 6 fulfils the function of improvement of light extraction efficiency from the LED 1 and thus its refractive index needs to be higher than that of the transparent resin 2 as mentioned above, the second taper rod 7 fulfils the function of the light intensity distribution conversion of emitted light, and thus if the refractive index of this part is lower, length of the taper rod can be made shorter. This is because, if a refractive index is lower, an angle of light relative to the normal direction of the incidence and emission planes in a taper rod becomes larger, and the light can reach a side face more easily. Accordingly, this embodiment can suppress the length of the whole body compared with the fourth embodiment when realizing equal light intensity distribution, and thus it can contribute to miniaturization of equipment.

Meanwhile, in the above example, although the first taper rod 6 and the second taper rod 7 are arranged having a slight gap, both of them may adhere tightly to each other or may be glued together. When they are glued together, if the refractive index of an adhesive material is made equal to that of the second taper rod 7, Anti-Reflective Coating to the incidence plane of the second taper rod 7 is unnecessary, and the cost can be reduced. Meanwhile, in this case, Anti-Reflective Coating of the emission plane of the first taper rod 6 will be designed so that it may function for the refractive index of the adhesive material.

### Sixth Exemplary Embodiment

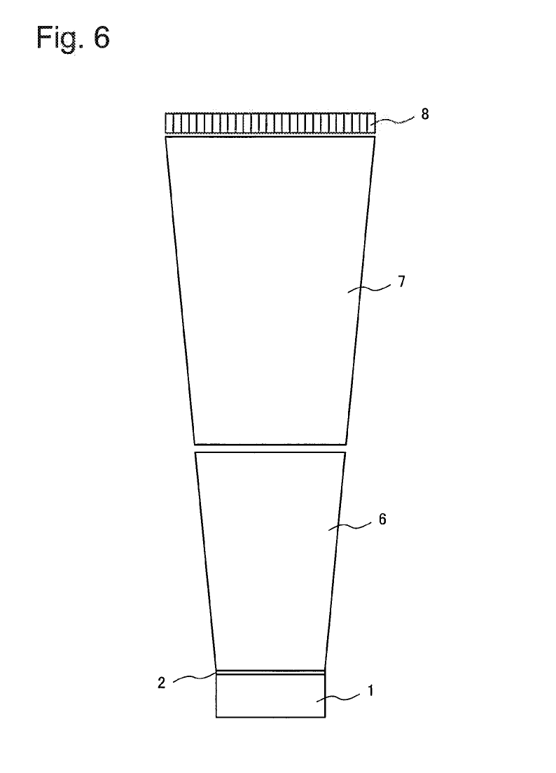

A luminescent device according to the sixth exemplary embodiment of the present invention will be described. FIG. 6 is a sectional view showing a structure of a luminescent device in the sixth exemplary embodiment of the present invention.

In the sixth exemplary embodiment of the present invention, an LED 1, a transparent resin 2, a first taper rod 6 and a second taper rod 7 are arranged in this order just like the fifth exemplary embodiment, and a reflective polarizer 8 is arranged on this. In the reflective polarizer 8, light having polarization parallel to a transmission axis direction penetrates, and remaining light is reflected. Because light from the LED 1 is unpolarized light, the ratio of penetrating light and reflected light here is roughly 1:1. Light reflected by the reflective polarizer 8 returns to the side of the LED 1 through the second taper rod 7, the first taper rod 6 and the transparent resin 2, and is reflected by the LED 1. At the time of reflection by the LED 1, due to influence of such as a textured structure of its surface, polarization is disordered and the light becomes unpolarized light again. Light reflected by the LED 1 goes toward the reflective polarization element 8 again. Here, once again, about half of the light penetrates through and the remaining half is reflected. By repeating this process, almost all light is taken out from the emission plane as a linearly polarized light in one direction finally. Even in this example, reflectivity in the LED 1 is increased just like the third example due to efficiency improvement of light extraction from the LED 1. Accordingly, compared with a case where the reflective polarizer 8 is arranged on the LED 1 directly, it is possible to make the re-utilization efficiency of reflected light high. Furthermore, as is the case with the fifth example, light from the emission plane of the second taper rod 7 is distributed in a narrow angular range of 0-30 degrees in this example. Because this light enters the reflective polarizer 8, incident angle tolerance required for the reflective polarizer 8 can be relaxed greatly.

Meanwhile, although it has been supposed that light that enters in the LED 1 and is reflected after that becomes unpolarized light in the above, there is also a case where this depolarization effect is insufficient depending on an LED. In this case, it is possible to insert a wavelength plate between the LED 1 and the reflective polarizer 8, such as between the second taper rod 7 and the reflective polarizer 8. Or, a diffusing plate may be inserted between the first taper rod 6 and the second taper rod 7. Meanwhile, in this case, it is desirable to have an air layer by not gluing the diffusing plate and the second taper rod 7 together at least.

In the above exemplary embodiments, cases where a structure of the present invention is applied to a red LED have been taken as an example. This is because a refractive index of a red LED made of an AlGaInP system crystal is higher than that of a blue and a green LED made of an InGaN system crystal, and thus light extraction efficiency is low and the effect of the present invention appears most remarkably. However, the present invention is also applicable to an LED with another color such as blue and green, and, furthermore, it is also applicable not only to an LED made of semiconductor but also to a light source of such as organic EL.

Meanwhile, as stated before, although it is desirable that an area ratio of incidence and emission planes of a taper rod is the second power of the refractive index of a transparent resin or more, in a case where a plurality of taper rods are arranged, this area ratio means the ratio between the incidence plane of the first taper rod and the emission plane of a taper rod from which light is emitted to the air first. For example, in the case of a structure like FIG. 5 described in the fifth exemplary embodiment, that is, when it has the first taper rod 6 and the second taper rod 7, and there is the air between those, it is the area ratio between the emission plane and the incidence plane of the first taper rod 7.

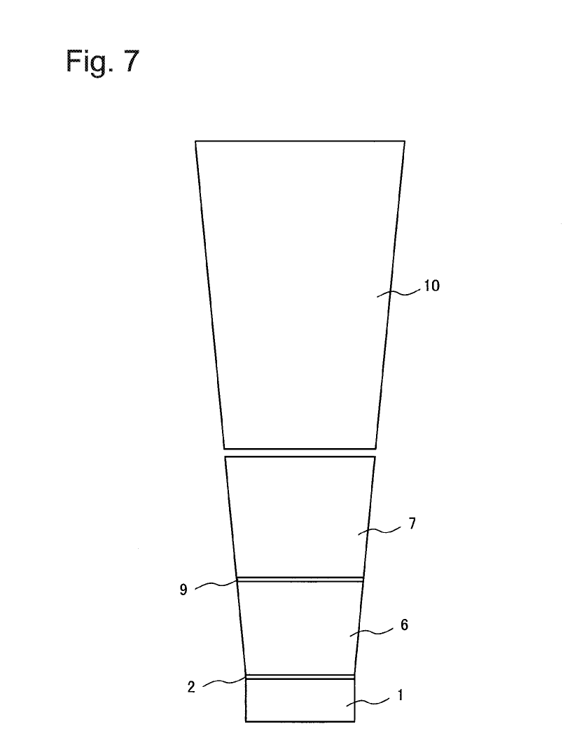

On the other hand, as shown in FIG. 7, in a case where a transparent resin 9 is filled between the first taper rod 6 and the second taper rod 7, and a third taper rod 10 or an optical component such as a lens is arranged in the latter stage sandwiching the air, it means the area ratio between the incidence plane of the first taper rod 6 and the emission plane of the second taper rod 7.

It is desirable that the luminous area of an LED and the area of the incidence plane of a taper rod just above it are approximately the same in a structure of the present invention. The reason of this is that when the incidence area of a taper rod is smaller, part of light is not taken in, and when the incidence area is larger, increase of Etendue is caused.

Although there is filled a transparent resin between an LED and a taper rod, this may be a clear adhesive material. When an adhesive material is used, the relative position between an LED and a taper rod can be maintained even when an impact and a vibration are added to a light source module.

Also, it is desirable that a transparent resin between an LED and a taper rod be thin as much as possible. The reason of this is to prevent light getting scattered and lost from a side face of a transparent resin. For the same reason, it is desirable that a coating area of a transparent resin be approximately the same as the luminous area of an LED.

Also, in the above-mentioned examples, although a taper rod having a fixed taper angle has been taken as an example, a taper angle may be changed from its incidence plane to its emission plane. In this case, it is desirable for the largest taper angle in the taper rod to meet Formula (1) indicated in the example 1.

Meanwhile, a transparent resin between an LED and a taper rod or a transparent resin 9 between the first taper rod 6 and the second taper rod 7 in FIG. 7 may be gelled or may be an adhesive material such as a thermal hardening type and a UV hardening type.

Although exemplary embodiments of the present invention have been described above, an implementation method of the present invention is not limited to the above-mentioned embodiments, and various modifications are possible within a range that does not deviate from the scope of the present invention.

This application claims priority based on Japanese Application Japanese Patent Application No. 2012-194034 filed on Sep. 4, 2012, the disclosure of which is incorporate herein in its entirety.

### REFERENCE SIGNS LIST

1 LED
2 Transparent resin
3 Taper rod
4 High reflection coating made of dielectrics
5 Angle filter
6 First taper rod
7 Second taper rod
8 Reflective polarizer
9 Transparent resin
10 Third taper rod

What is claimed is:

1. A luminescent device, comprising:
a light emitting element; a taper rod having an area of an emission plane larger than an area of an incidence plane; a transparent resin being filled between said light emitting element and said taper rod; and at least part of said taper rod having a refractive index higher than a refractive index of said transparent resin.

2. The luminescent device according to claim 1, wherein
a luminous area of said light emitting element and an area of an incidence plane of said taper rod are approximately equal.

3. The luminescent device according to claim 1, wherein
said taper rod is formed based mainly on a material having a refractive index higher than a refractive index of said transparent resin.

4. The luminescent device according to claim 1, wherein
an area ratio of an emission plane to an incidence plane of said taper rod is equal to a second power of a refractive index of said transparent resin or more.

5. The luminescent device according to claim 1, wherein
said light emitting element has a light emitting layer, said light emitting layer having AlGaInP as a main component.

6. The luminescent device according to claim 3, wherein,
given that a biggest taper angle of said taper rod is θt, a refractive index of a transparent resin is n1, and a refractive index of a taper rod is n2, θt, n1 and n2 satisfy a following condition of:
n2×cos {sin⁻¹(n1/n2)−θt}≧1.

7. The luminescent device according to claim 1, wherein
a dielectric reflection film is formed onto side surfaces of said taper rod.

8. The luminescent device according to claim 1, further comprising:
in a stage after said taper rod, an optical element to make part of emitted light in a certain state transmit through said optical element, and make light besides that be reflected.

9. The luminescent device according to claim 1, further comprising:
a second taper rod in a stage after said emission plane of said taper rod.

10. The luminescent device according to claim 9, wherein
a refractive index of said second taper rod is lower than a refractive index of a first taper rod.
